(19) United States
(12) Patent Application Publication
(10) Pub. No.: US 2026/0089601 A1
(43) Pub. Date: Mar. 26, 2026

(54) EXPEDITED RECOVERY FROM PREFERRED RADIO ACCESS TECHNOLOGY (RAT) COVERAGE HOLE AIDED BY ON-BOARD VEHICLE SENSORS

(71) Applicant: QUALCOMM Incorporated, San Diego, CA (US)

(72) Inventors: Soumya DAS, San Diego, CA (US); Mohsen BAHRAMI, Carlsbad, CA (US)

(21) Appl. No.: 18/892,066

(22) Filed: Sep. 20, 2024

(51) Int. Cl. H04W 36/32; H04W 4/40; H04W 36/30

(52) U.S. Cl. CPC H04W 36/322; H04W 4/40; H04W 36/302

(57) ABSTRACT

A method for wireless communication at a vehicular user equipment (UE) includes evaluating preferred radio access technology (RAT) coverage criteria. The method also includes identifying a vehicle mobility state associated with vehicle specific information. The method further includes calculating a time to trigger a preferred RAT coverage recovery associated with the vehicle mobility state and the preferred RAT coverage criteria. The method still further includes performing an expedited idle mode/connected mode frequency scan in accordance with the time to trigger the preferred RAT coverage recovery, prior to the vehicular UE departing an area comprising a coverage hole.

### FIELD OF THE DISCLOSURE

Aspects of the present disclosure generally relate to wireless communications, and more specifically to expedited recovery from a preferred radio access technology (RAT) coverage hole aided by on-board vehicle sensors.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as long term evolution (LTE) systems, LTE-Advanced (LTE-A) systems, or LTE-A Pro systems, and fifth generation (5G) systems which may be referred to as new radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Situations exist in which a user equipment (UE), such as a vehicle UE, is parked or operates in a poor or limited coverage area for a preferred radio access technology (RAT). The poor or limited coverage area is an example of a coverage hole. In these situations, coverage for lower priority RATs may be available or better than the coverage for the preferred RAT (e.g., higher priority RAT). To improve the user experience and handle stringent specifications of certain connected vehicle applications, when the UE switches to the lower priority RAT in the area associated with the coverage hole, the UE should transition to the higher priority RAT as soon as the vehicle exits the area associated with the coverage hole. It would be desirable to reduce an amount of time for recovering from the coverage hole.

### SUMMARY

In aspects of the present disclosure, a method for wireless communication at a vehicular user equipment (UE) includes evaluating preferred radio access technology (RAT) coverage criteria. The method also includes identifying a vehicle mobility state associated with vehicle specific information. The method further includes calculating a time to trigger a preferred RAT coverage recovery associated with the vehicle mobility state and the preferred RAT coverage criteria. The method still further includes performing a first mode frequency scan in accordance with the time to trigger the preferred RAT coverage recovery, prior to the vehicular UE departing an area comprising a coverage hole.

Other aspects of the present disclosure are directed to an apparatus. The apparatus has a memory and one or more processors coupled to the memory. The processor(s) is configured to evaluate preferred radio access technology (RAT) coverage criteria. The processor(s) is still further configured to identify a vehicle mobility state associated with vehicle specific information. The processor(s) is further configured to calculate a time to trigger a preferred RAT coverage recovery associated with the vehicle mobility state and the preferred RAT coverage criteria. The processor(s) is still further configured to perform a first mode frequency scan in accordance with the time to trigger the preferred RAT coverage recovery, prior to the vehicular UE departing an area comprising a coverage hole.

In other aspects of the present disclosure, a non-transitory computer-readable medium with program code recorded thereon is disclosed. The program code is executed by a processor and includes program code to evaluate preferred radio access technology (RAT) coverage criteria. The program code also includes program code to identify a vehicle mobility state associated with vehicle specific information. The program code further includes program code to calculate a time to trigger a preferred RAT coverage recovery associated with the vehicle mobility state and the preferred RAT coverage criteria. The program code still further includes program code to perform a first mode frequency scan in accordance with the time to trigger the preferred RAT coverage recovery, prior to the vehicular UE departing an area comprising a coverage hole.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 shows an example of a wireless communications system that supports expedited preferred radio access technology (RAT) coverage recovery, in accordance with various aspects of the present disclosure.

FIG. 2A shows an example of network availability within two regions, in accordance with various aspects of the present disclosure.

FIG. 2B shows an example of the regions of FIG. 2A divided into zones, in accordance with various aspects of the present disclosure.

FIG. 3 shows an example of zone-based time to trigger mitigation to recover from a preferred RAT coverage hole, in accordance with various aspects of the present disclosure.

FIGS. 4A-4C are flow diagrams illustrating expedited recovery for preferred RAT coverage, in accordance with various aspects of the present disclosure.

FIG. 5 is a flow diagram illustrating a processor-implemented method for expedited recovery for preferred RAT coverage, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G, 6G, and later wireless technologies, aspects of the present disclosure can be applied in other generation-based communications systems, such as and including 3G and/or 4G technologies.

In wireless communication systems, user equipment (UEs), such as vehicular UEs, may be configured with preferred radio access technologies (RATs) for wireless communication. For example, a UE may be configured with a priority for a fifth generation (5G) network, such as new radio (NR), over a fourth generation (4G) network, such as long term evolution (LTE).

Situations exist in which a UE, such as a vehicle UE, is parked or operates in a poor or limited coverage area for a preferred radio access technology (RAT). The poor or limited coverage area may be an example of an area associated with a coverage hole. A coverage hole also refers to a preferred RAT coverage hole and/or a network coverage hole. In these situations, coverage for lower priority RATs may be available or better than the coverage for the preferred RAT (e.g., higher priority RAT). To improve the user experience and handle stringent specifications of certain connected vehicle applications, when the UE has transitioned to the lower priority RAT in the area associated with the coverage hole, the UE should transition to the higher priority RAT as soon as the vehicle exits the area associated with the coverage hole. It would be desirable to reduce an amount of time for recovering from the coverage hole.

Aspects of the present disclosure introduce a solution for a modem (or modem application processor (AP)) in a vehicular UE to quickly and more reliably recover from a preferred RAT coverage hole. In some aspects, the solution may include a machine learning-based solution that outputs a time to trigger a preferred RAT coverage recovery associated with a vehicle mobility state and a preferred RAT coverage criteria. The time to trigger the preferred RAT coverage recovery enables performing of a first mode frequency scan, also referred to as an expedited idle mode/connected mode frequency scan. Inputs to the machine learning model may include predicted preferred RAT coverage information, for example, reference signal received power (RSRP), reference signal received quality (RSRQ), and/or signal-to-interference plus noise ratio (SINR), as well as a predicted vehicle mobility state within a predicted vehicle trajectory.

In other aspects, vehicle on-board sensor information may be fused with network information and vehicle state information. For example, gear mode, ignition status, a no passenger detection signal, as well as positioning information precision may aid the modem in reliably inferring the type of environment where the preferred RAT coverage hole is detected. The fused sensor information may also enable the modem to quickly apply an appropriate mitigation solution.

In still other aspects, inferred information from one or more vehicle cameras may improve coverage recovery. For example, the UE may infer whether a vehicle is in a garage or a tunnel from one or more camera images. The inferred information may reduce false alarm detection and events where the modem prematurely applies mitigation. Alternatively, vehicle trip history information and/or map data may enhance the reliability and performance of preferred RAT coverage hole recovery mitigation in vehicular UEs.

According to aspects of the present disclosure, a modem may predict the time to trigger mitigation to recover from a preferred RAT coverage hole for a future or pre-configured segment of a UE route, referred to as future zones. The proposed predictive solution may be based on a detected environment type, predicted preferred RAT coverage information, anticipated UE mobility level, and a predicted vehicle trajectory. As a result, a UE can return to service more quickly from a coverage hole.

Particular aspects of the subject matter described in this disclosure can be implemented to realize one or more of the following potential advantages. In some examples, the expedited recovery from a preferred RAT coverage hole may improve the UE experience, for example by reducing latency and increasing throughput. For example, latency is reduced because the UE is able to return to network coverage more quickly. Fusing vehicle on-board sensors information with network and UE motion information aids the modem to reliably infer the type of environment where a coverage hole is detected and to apply the appropriate mitigation solution. By determining the environment in which the UE is operating, the UE may reduce false alarm detection and events where the modem prematurely applies mitigation. Furthermore, vehicle trip history information or map data can be used to enhance the reliability and performance of coverage hole recovery mitigation in a vehicular UE.

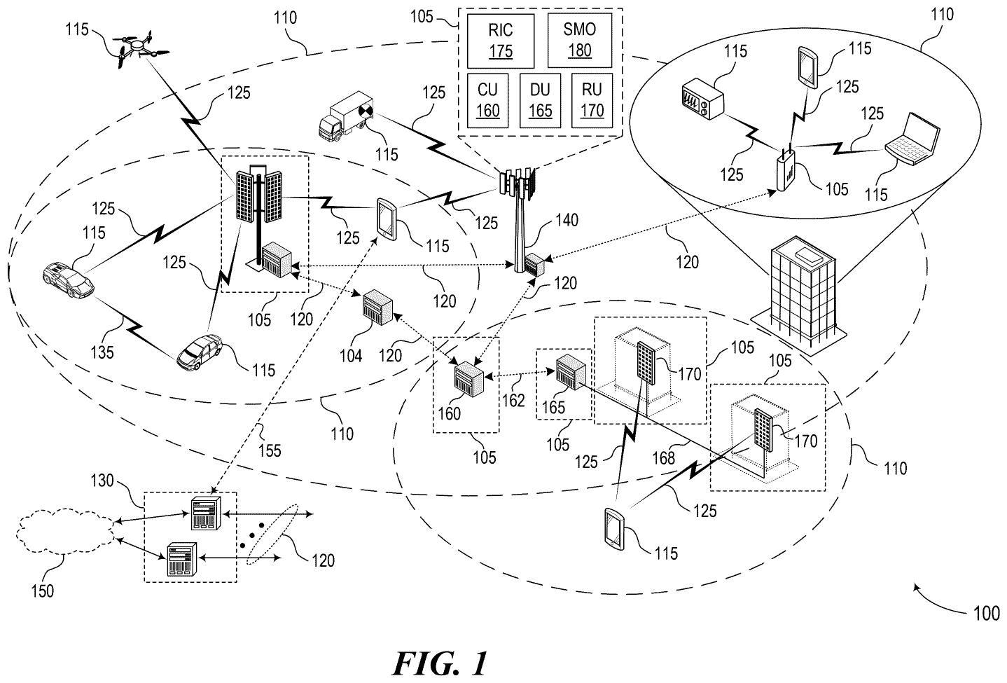

FIG. 1 shows an example of a wireless communications system 100 that supports expedited preferred RAT coverage recovery, in accordance with various aspects of the present disclosure. The wireless communications system 100 may include one or more network entities 105, one or more UEs 115, and a core network 130. In some examples, the wireless communications system 100 may be a long term evolution (LTE) network, an LTE-Advanced (LTE-A) network, an LTE-A Pro network, a new radio (NR) network, or a network operating in accordance with other systems and radio technologies, including future systems and radio technologies not explicitly mentioned.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described may be capable of supporting communications with various types of devices, such as other UEs 115 or network entities 105, as shown in FIG. 1.

As described, a node of the wireless communications system 100, which may be referred to as a network node, or a wireless node, may be a network entity 105 (e.g., any network entity described), a UE 115 (e.g., any UE described), a network controller, an apparatus, a device, a computing system, one or more components, or another suitable processing entity configured to perform any of the techniques described. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques applied to the context of a disaggregated RAN architecture, one or more components of the disaggregated RAN architecture may be configured to support subscriber identity module switching based on predicted utility as described. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via machine-to-machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP multimedia subsystem (IMS), or a packet-switched streaming service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ license assisted access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Many situations exist in which a user equipment (UE), such as a vehicle UE, is parked or operates in a poor or limited coverage area for a preferred radio access technology (RAT). Examples of preferred RATs include new radio (NR) and new radio time division duplexed (NR-TDD). In these situations, coverage for lower priority RATs, such as LTE or new radio frequency division duplexed (NR-FDD) coverage, may be available or better than the coverage for the preferred RAT (e.g., higher priority RAT). To improve the user experience and handle stringent specifications of certain connected vehicle applications, for example, tele-operated driving, the UE should transition to the higher priority radio access technology (RAT) (e.g., LTE to NR or NR-FDD to NR-TDD) as soon as the vehicle exits the area associated with coverage hole. Some non-limiting examples of locations (e.g., areas) associated with coverage holes are a basement, an underground or structured parking garage, a factory, a warehouse, an auto manufacturing plant, and a tunnel.

Existing solutions are primarily developed for handheld UEs to detect when the UE is in a preferred RAT coverage hole using UE mobility events for faster recovery from the preferred RAT coverage hole in both idle and connected modes. However, certain shortcomings in vehicle applications should be addressed. For example, in handheld UEs, a modem has access to limited information to reliably determine whether the UE is in a basement, a tunnel, or a parking garage in order to apply the mitigation actions relevant for the environment or underlying situation. Relying only on UE mobility events may result in false alarm detection or cause the modem to prematurely apply mitigation, such as an aggressive frequency scan.

It would be desirable to reduce an amount of time for recovering from a preferred RAT coverage hole. Aspects of the present disclosure introduce a solution for a modem (or modem application processor (AP)) in a vehicular UE to quickly and more reliably recover from a preferred RAT coverage hole. The solution may be a machine learning-based solution, in some aspects. Inputs to the machine learning model may include predicted preferred RAT coverage information, for example, reference signal received power (RSRP), reference signal received quality (RSRQ), and/or signal-to-interference plus noise ratio (SINR), as well as a predicted vehicle mobility state within a predicted vehicle trajectory.

The preferred RAT coverage information (or map) may include one or more of signal strength (e.g., RSRP), signal quality (e.g., RSRQ, SINR), frequency range (e.g., sub6 GHz, low band/mid band/high band, mmW), inferred NW deployment type (e.g., standalone (SA), non-standalone (NSA), time division duplexed (TDD) or frequency division duplexed (FDD)), or other information such as a base station transmitter (Tx) antenna configuration.

In other aspects, vehicle on-board sensor information may be fused with network information and vehicle state information. For example, gear mode (e.g., park vs. drive), ignition status (e.g., OFF vs. ON), a no passenger detection signal, as well as positioning information (e.g., global positioning system (GPS) or global navigation satellite system (GNSS)) precision (e.g., low or no coverage vs. high precision) may aid the modem to reliably infer the type of environment where the preferred RAT coverage hole is detected. The fused sensor information may also enable the modem to quickly apply an appropriate mitigation solution. This vehicle information may be available to a vehicular UE from engine control units (ECUs), vehicle sensors via a controller area network (CAN) bus, Ethernet, and/or other interface within the vehicle.

In still other aspects, inferred information from one or more vehicle cameras may improve coverage recovery. For example, the UE may infer whether a vehicle is in a garage or a tunnel from one or more camera images. The images may be two-dimensional or three-dimensional images. The inferred information may reduce false alarm detection and events where the modem prematurely applies mitigation. Alternatively, vehicle trip history information and/or map data may enhance the reliability and performance of preferred RAT coverage hole recovery mitigation in vehicular UEs.

According to aspects of the present disclosure, a modem predicts the time to trigger mitigation to recover from a preferred RAT coverage hole for a future or pre-configured segment of a UE route, referred to as future zones. The proposed predictive solution may be based on a detected environment type, predicted preferred RAT coverage information, anticipated UE mobility level, and/or a predicted vehicle trajectory.

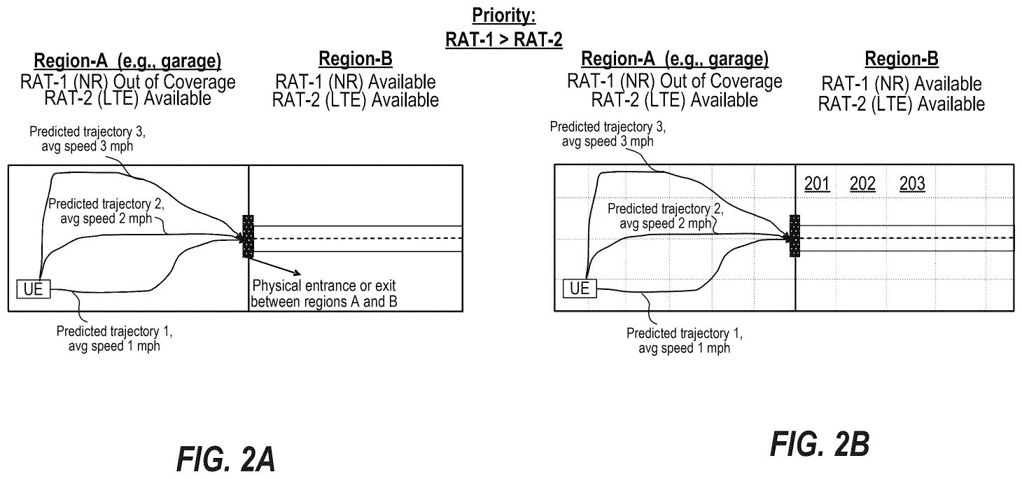

FIG. 2A is a diagram illustrating an example of network availability within two regions, in accordance with various aspects of the present disclosure. FIG. 2B is a diagram illustrating an example of the regions of FIG. 2A divided into zones, in accordance with various aspects of the present disclosure. In a first example scenario shown in FIGS. 2A and 2B, a vehicle (UE) is parked in an underground garage in region-A, where NR coverage (RAT-1) is not available (out of coverage (OOC)). RAT-1 is a higher priority RAT in this example. A lower priority RAT-2 (LTE) is available in region-A. When exiting the garage into region-B, the UE wants to transition to NR as soon as possible. In region-B, both RAT-1 and RAT-2 are available. In the example of FIGS. 2A and 2B, three trajectories are predicted. In the first predicted trajectory (trajectory 1), the average speed is 1 mile per hour (mph). In the second predicted trajectory (trajectory 2), the average speed is 2 mph. In the third predicted trajectory (trajectory 3), the average speed is 3 mph.

FIG. 2B shows each region divided into zones. Only three zones 201, 202, 203 of region-B are labeled to prevent unnecessary clutter. A zone may be a geographic area defined by a set of geographic coordinates that outline the borders of a respective zone. Thus, the UE may travel within a set of zones or geographic areas on a route where coverage may vary in each zone of the set of zones.

According to aspects of the present disclosure, a modem expedites recovery from the preferred RAT coverage hole, for example an NR coverage hole, by predicting a time to trigger recovery mitigation based on predicted preferred RAT coverage information and a vehicle mobility level within each zone along a predicted vehicle trajectory. The modem may leverage historical preferred RAT coverage data from past vehicle trips or frequently visited locations to predict the preferred RAT coverage information for future zones. If this information is not available locally, the historical data may be obtained from crowdsourced data, such as via a cloud service.

In some aspects, a machine learning (ML) solution is implemented. Inputs or features for the ML-based solution may be provided in a per zone format for each UE along the vehicle route. The vehicle route may either be given or predicted from user inputs (e.g., in a map) or a user history. For example, a UE may enter an office parking garage between 8:50-9:10 am, exiting the office parking garage between 5:20-5:40 pm on workdays, etc. Example inputs include cellular information, signal quality information, UE mobility information, and vehicle mobility and location information. The map information may include the actual map area location, for example, the parking garage location, the parking entrance, the parling exit, etc., that may be stored in the vehicle, such as in an in-vehicle infotainment system or advanced driving assist system (ADAS) module.

Cellular information may include the cell global identifier (CGI), physical cell identifier (PCI), absolute radio frequency channel number (ARFCN), and RAT type (e.g., LTE, NR standalone (SA) or non-standalone (NSA)) information. Signal quality information may include RSRP, SINR, and reference signal receive quality (RSRQ) from a current reference signal, such as a channel state information reference signal (CSI-RS) or a synchronization signal block (SSB), measurements or past measurements from a cell history database. The cell history database may be based on on-device learning or crowdsourced data, for example.

A UE may predict the preferred RAT coverage information based on current and past UE reference signal measurements, radio resource control (RRC) configurations, and downlink/uplink (DL/UL) grant information for current and previous zones as well as the history of such information from the modem cell history database for the future zones within the predicted UE trajectory or path. If the information is not available locally, the information may be retrieved from crowdsourced information.

UE mobility information may include information from current network configurations or past network configurations from the cell history database. For example, the information may include the number of downlink component carriers, the aggregate downlink bandwidth, the number of downlink layers, the number of uplink component carriers, the aggregate uplink bandwidth, the number of uplink layers, an NR to LTE mobility event, an LTE to NR mobility event, and/or an NR-TDD to NR-FDD mobility event.

Vehicle mobility and location information may include a position, velocity, time stamp (PVT) report, and/or heading/direction information. UE motion prediction may include the UE predicting an average speed and the environment type, for example, parking garage, in future zones based on a combination of the MAP information, UE or vehicle user trip information, and/or other UE or vehicle sensor information such as location, speed, and/or heading from GNSS and an IMU.

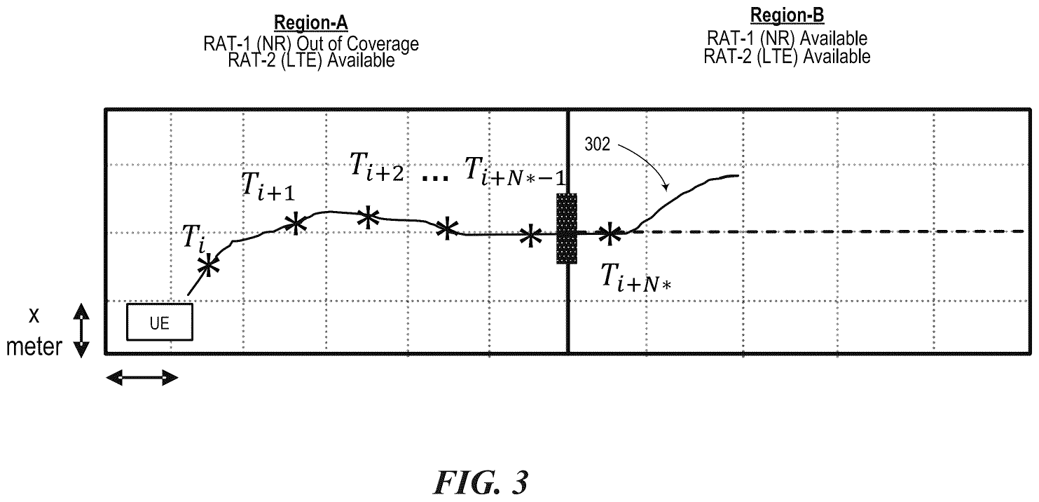

An example implementation will now be described with respect to FIG. 3. FIG. 3 is a diagram illustrating an example of zone-based time to trigger mitigation to recover from a preferred RAT coverage hole, in accordance with various aspects of the present disclosure. In order to calculate the time to trigger mitigation, the modem obtains a given or predicted vehicle trajectory and detects a preferred RAT coverage hole. In the example of FIG. 3, a trajectory 302 is shown traversing region-A into region-B. The modem may infer the type of environment of the UE based on inputs from different vehicle sensors and ECUs. The type of environment may be used to more reliably and accurately predict vehicle mobility level and preferred RAT coverage information.

At each zoneᵢ, the modem predicts the time to trigger mitigation to recover from the detected preferred RAT coverage hole for each zoneᵢ T_{zone(i)} as follows:

$${T}_{zone ( i )} = f ( predicted vehicle mobility {level}_{zone [ i : i + W - 1 ]} , predicted preferred RAT coverage {info}_{zone [ i : i + W - 1 ]}$$

where the current zone i is defined such that [i: i+W−1]={i, i+1, . . . , i+W−1}, and W represents the depth of future zones (e.g., if three zones exist, W=3).

The predicted vehicle mobility level_{zone[i:i+W-1]} and the predicted preferred RAT coverage info_{zone[i:i+W-1]} are vectors of predicted values for vehicle mobility level and preferred RAT coverage information in the current and next W−1 future zones, respectively. Specifically, predicted vehicle mobility level_{zone[i:i+W]}=(predicted vehicle mobility level_{zone(i)}, predicted vehicle mobility level_{zone(i+1)}, . . . , predicted vehicle mobility level_{zone(i+w)}).

The function ƒ forecasts the remaining time until triggering conditions for applying mitigation to recover from the preferred RAT coverage hole are expected to be satisfied. This prediction is based on the predicted vehicle motion level and predicted preferred RAT coverage information (e.g., RSRP, SINR, RSRQ) in the current and future (W−1) zones, along with the predicted vehicle trajectory. Without loss of generality, any ML model can be used for the implementation of ƒ. It is noted that the mitigation conditions that are considered to predict the time to trigger recovery mitigation are the actual triggering conditions and not relaxed triggering conditions.

In the example of FIG. 3, the UE is predicted to travel along the trajectory 302, where each zone (zoneᵢ) has a size of x square meters. The trajectory 302 traverses zoneᵢ to zone_{i+N*}, where N* is the first zone in the region-B having coverage for the preferred RAT A first time to trigger in a first zone Tᵢ may be calculated, along with a time to trigger in each of the future zones i+1, i+2 . . . i+N*.

After calculating the time to trigger for each zone, the modem determines whether relaxed triggering conditions for applying the mitigation are satisfied. The relaxed conditions may be satisfied if |T_{i+N*}|<Δ, in which case the modem applies the recovery mitigation at zone_{i+N*}. The threshold Δ may be a preconfigured value (e.g., 0, 0.1 seconds, or 1 second) or adaptively determined. The threshold Δ may be adaptively set based on a distribution or statistics of predicted time to trigger samples. For example, if a high fidelity coverage map is available, the threshold Δ may be set lower than if a high fidelity coverage map is not available.

An example of relaxed conditions for triggering recovery mitigation may relate to evaluating triggering conditions. That is, instead of evaluating triggering conditions for an original duration (T_cond), the triggering conditions may be evaluated for a shorter duration (T*_cond), where T*_cond<T_cond. In another example, relaxed triggering conditions may pertain to checking the RAT-1 cell presence. In this example, when exiting a RAT-1 coverage hole, the modem may check for the presence of RAT-1 cells for a reduced duration (T*_coverage) instead of the original duration (T_coverage), where T*_coverage<T_coverage. Another example of relaxed conditions is based on a signal quality jump for the available RAT. For example, while leaving a RAT-1 (e.g., NR) coverage hole, evaluation occurs for the signal quality jump for RAT-2 (e.g., LTE) with a smaller jump threshold (L*dB) instead of (L dB), where L*<L.

If the relaxed trigger conditions are not satisfied, and the actual conditions for triggering recovery mitigation are met, the modem applies mitigation to recover from the preferred RAT coverage hole in accordance with the predicted time to trigger for each zone T_{zone(i)}. Otherwise, the modem checks whether the preferred RAT coverage hole is still detected. If so, the modem repeatedly determines if the relaxed or actual trigger conditions are satisfied and if the coverage hole is still detected. If not, the modem exits the loop.

Specific examples will now be described for preferred RAT coverage hole scenario determination aided by one or more on-board sensors of the vehicle.

Garage mode detection and expedited recovery from an NR or NR-TDD coverage hole is a first example. In this example, the modem infers the UE is in a coverage hole because the vehicle is parked in a garage or basement. The inference is based on the sensors indicating for T_1 seconds: the gear mode is parked, the ignition status is OFF, the no passenger signal is TRUE, the vehicle mobility is indicated as stationary, and the GNSS/GPS precision/accuracy is indicated as low or no coverage. The modem infers that the vehicle is exiting the garage or basement when for T_2 seconds the gear mode is not in park, the ignition status is ON, the no passenger signal is FALSE, the vehicle mobility is indicated as moving, and the GNSS/GPS precision/accuracy is indicated as low or no coverage. The modem predicts the time to trigger a faster search for the higher priority RAT, or an increased out-of-service (OOS) scan rate, based on a predicted vehicle trajectory and speed as well as a preferred RAT coverage prediction. The modem applies the recovery mitigation when the predicted time to trigger is less than a preconfigured value, and relaxed conditions for applying recovery mitigation (once the modem detects the vehicle is exiting the coverage hole) are satisfied.

Expedited recovery from a detected tunnel-based preferred RAT coverage hole is a second example. In this example, the modem infers that the UE is in a coverage hole because the vehicle is in a tunnel. The inference is based on the sensors indicating for T seconds that the gear mode is not parked, the ignition status is ON, the no passenger signal is FALSE, the vehicle mobility is indicated as moving, and the GNSS/GPS precision/accuracy is indicated as low or no coverage. In this example, the modem predicts the time to trigger an increased OOS scan rate, based on predicted speed and preferred RAT coverage when the GNSS/GPS precision/accuracy is predicted to improve within a predicted vehicle trajectory. The modem applies the recovery mitigation when the predicted time to trigger is less than a preconfigured value and relaxed conditions for applying recovery mitigation (once the modem detects the vehicle is exiting the tunnel) are satisfied.

Preferred terrestrial network (TN) deep out-of-service (OOS) region detection and expedited transition to a non-terrestrial network (NTN) is a third example. In this example, the modem infers that the coverage hole results from the vehicle being in a deep OOS scenario. The inference is based on the sensors indicating for T seconds that the terrestrial network (e.g., NR or LTE) is OOS, the no passenger signal is FALSE, and the GNSS/GPS precision/accuracy is high. The modem predicts the time to trigger a foreground search for NTN service to more quickly find an NTN cell, based on predicted vehicle trajectory and speed as well as preferred RAT coverage prediction. The modem applies the recovery mitigation when the predicted time to trigger is less than a preconfigured value and relaxed conditions for applying recovery mitigation (once the modem detects the vehicle is in a deep OOS region for a period of time) are satisfied.

Proposed inputs to be used by a modem, such as a modem application processor, include the gear mode (e.g., park vs. not parked), the ignition status (e.g., ON vs. OFF), and the no passenger detection or seat belt ON signal (e.g., TRUE vs. FALSE) from controller area network (CAN) buses or an Ethernet interface. Additionally, a position location (e.g., GPS/GNSS) precision/accuracy may be indicated as low or no coverage vs. high, and vehicle mobility from an inertial measurement unit (IMU) may be indicated as stationary vs. moving.

Additional aspects to improve the reliability of coverage hole recovery are now discussed. These additional aspects use road, area, and/or building images along with traffic signs captured by vehicle cameras. In some aspects, detection of the environment with a coverage hole fuses images captured by vehicle cameras. When a coverage hole is detected, the modem (or modem application processor (AP)) infers the type of environment and underlying scenario using vehicle camera images from the road and surrounding areas. For example, the images may help the modem infer whether the vehicle is inside a tunnel, in a basement or parking garage, or in a deep out-of-service (OOS) region. Other vehicle signals may assist with the inference.

In other aspects, detection of a coverage hole environment fuses road sign images captured by one or more vehicle cameras. When a coverage hole is detected, the modem (or modem AP) infers the type of environment and underlying scenario using road/street sign as well as building images. For example, the images may capture a parking garage entrance sign, a tunnel sign, national park sign, etc., captured by vehicle cameras.

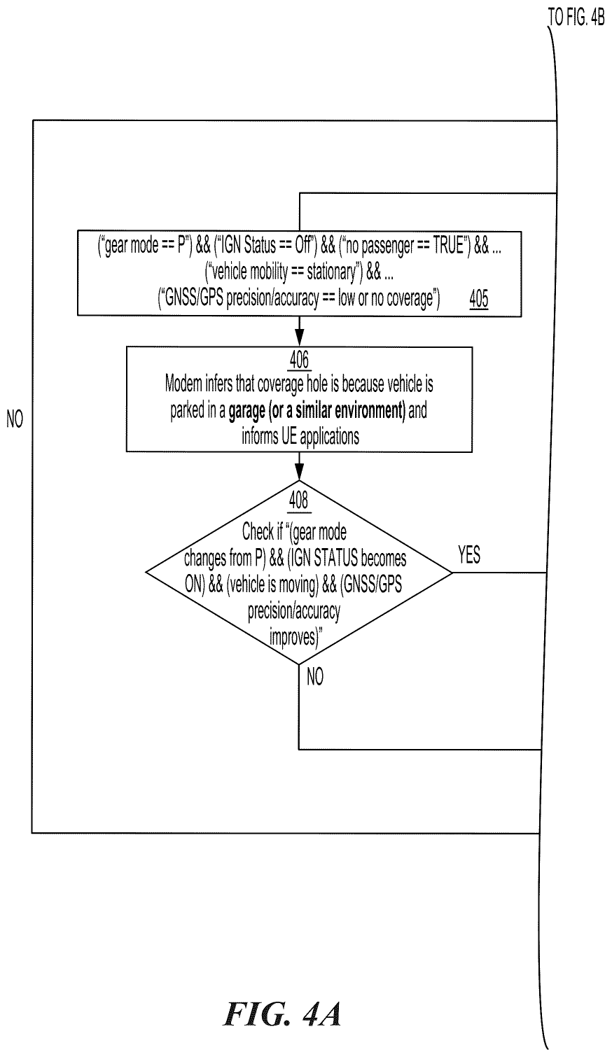

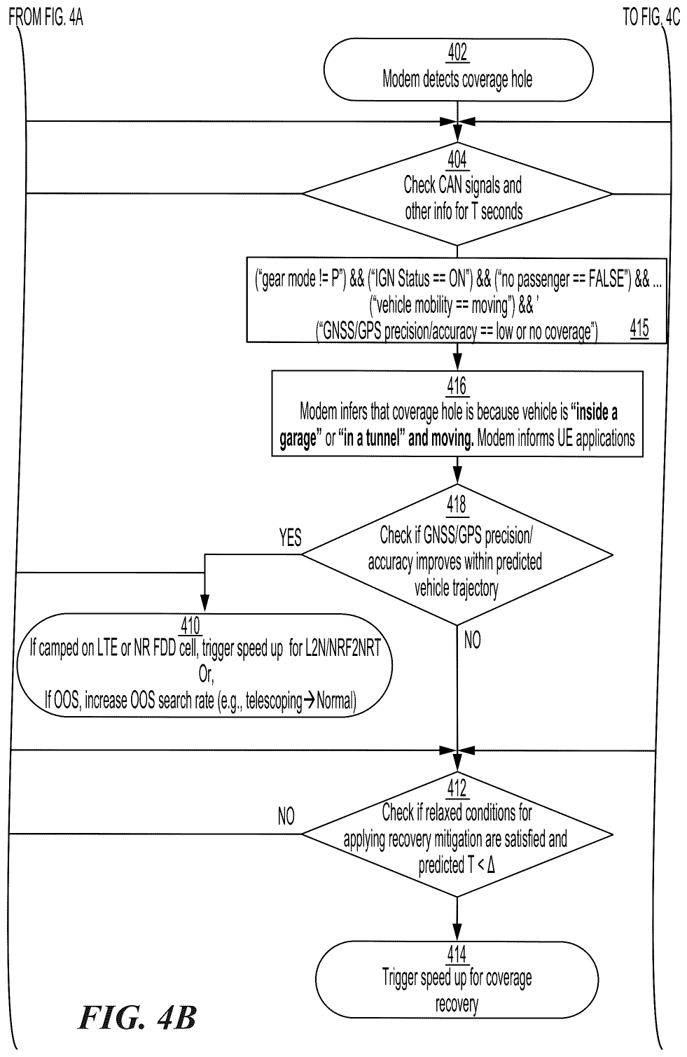

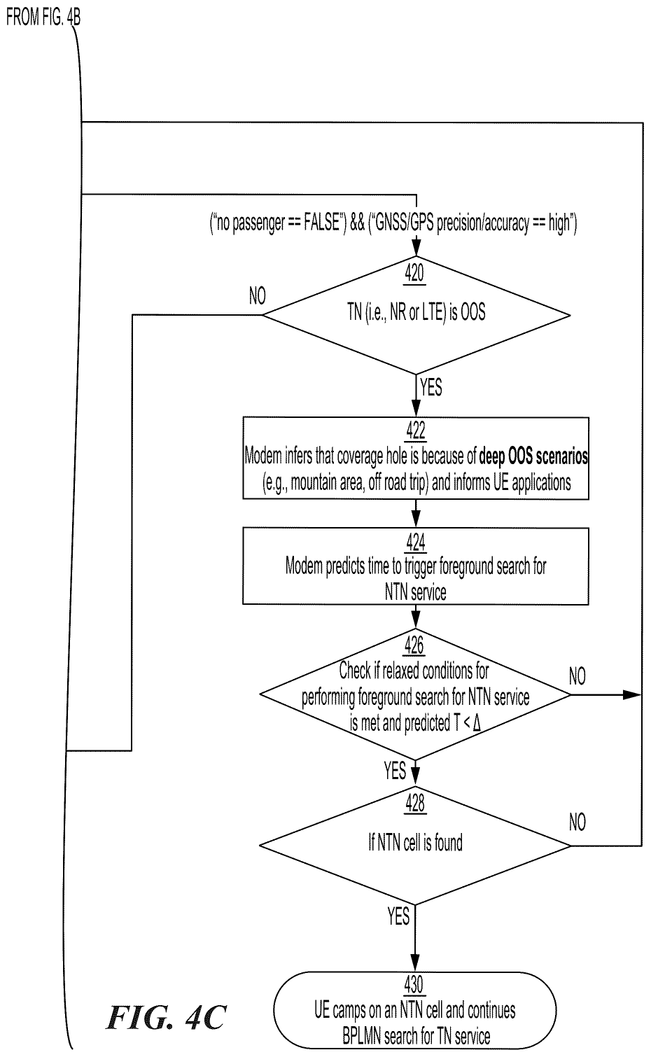

FIGS. 4A-4C are flow diagrams illustrating an example of expedited recovery for preferred RAT coverage, in accordance with various aspects of the present disclosure. In the example of FIGS. 4A-4C, at block 402, the modem detects a preferred RAT coverage hole. At block 404, the modem checks signals from the CAN bus, as well as other signals, for a period of time (e.g., T seconds.) At block 405, if the gear mode is parked, the ignition status is OFF, the no passenger signal is TRUE, the vehicle mobility is indicated as stationary, and the position location (e.g., GNSS/GPS) precision/accuracy is indicated as low or no coverage, at block 406, the modem infers that the coverage hole exists because the vehicle is in a garage or similar environment. The modem informs other applications of the inferred environment.

At block 408, the modem checks whether the gear mode changes from parked, the ignition status becomes ON, the vehicle mobility is indicated as moving, and the position location precision/accuracy improves. If so, at block 410, the modem determines whether the UE is camped on a non-preferred RAT (e.g., LTE), in which case the modem triggers an expedited LTE to NR (L2N) transition. Alternatively, if the UE is detected to be out of service, the modem increases the out-of-service search rate (e.g., from telescoping to normal).

If, at block 408, the outcome is FALSE, at block 412, the UE checks whether relaxed conditions for applying recovery mitigation are satisfied and a predicted time T is less than a threshold (A). At block 414, the modem triggers a speed up for preferred RAT coverage recovery if the relaxed conditions are satisfied and the predicted time is less than the threshold. Otherwise, the process returns to block 404.

If, at block 415, the gear mode is not parked, the ignition status is ON, the no passenger signal is FALSE, the vehicle mobility is indicated as moving, and the position location precision/accuracy is indicated as low or no coverage, at block 416, the modem infers that the coverage hole exists because the vehicle is in a garage or similar environment or in a tunnel, and also that the vehicle is moving. The modem informs UE applications of the inferred environment. At block 418, the modem determines whether the position location accuracy or precision improves within a predicted vehicle trajectory. If so, the process proceeds to block 410. If not, the process flows to block 412.

If, at block 404, the no passenger signal is FALSE and the position location precision/accuracy is indicated as high, at block 420, the modem determines whether the terrestrial network (TN) (e.g., NR or LTE) is out of service. If not, the process flows to block 412. If the TN is OOS, at block 422, the modem infers the coverage hole is due to a deep out-of-service scenario, such as being within a mountainous area, off-road, etc. The modem informs the UE applications of the inferred environment. At block 424, the modem predicts a time to trigger a foreground search for a non-terrestrial network (NTN).

At block 426, the modem checks whether relaxed conditions for performing the foreground search for NTN service are met and the predicted time T is less than a threshold (A). If the conditions are not met, the process returns to block 404. If the conditions are met, at block 428 the modem determines whether an NTN cell is found. If not, the process returns to block 404. If an NTN cell is found, the UE camps on the NTN cell and continues a background public land mobile network (BPLMN) search for terrestrial network service at block 430.

Aspects of the present disclosure introduce solutions for reliably detecting the environment where a preferred RAT coverage hole exists, as well as machine learning-based expedited preferred RAT coverage recovery that simultaneously considers a comprehensive set of on-board vehicle sensors, predicted preferred RAT coverage, and a predicted vehicle mobility state. The sensors may include a gear mode, a no passenger detection signal, vehicle mobility from an IMU, and GNSS/GPS precision/accuracy.

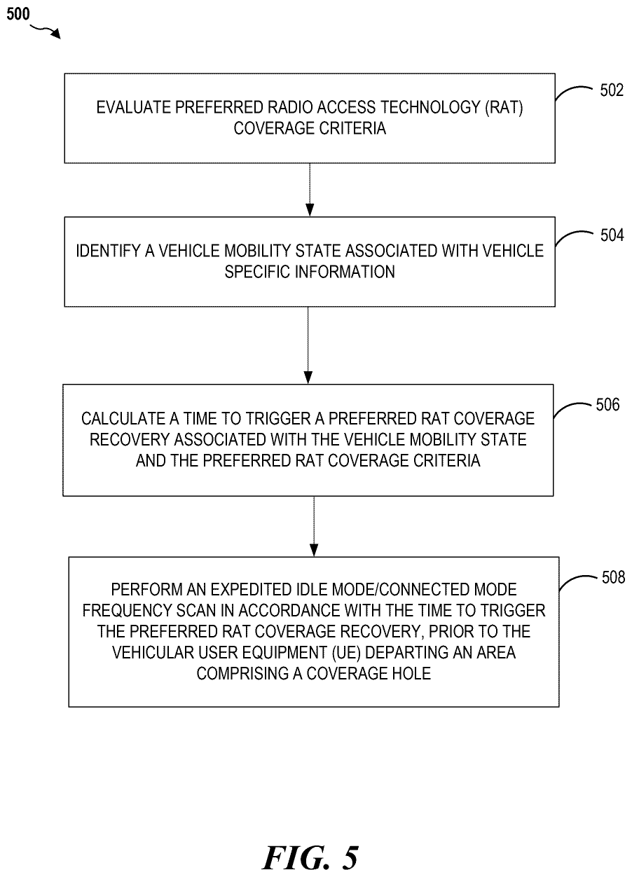

FIG. 5 is a flow diagram illustrating a processor-implemented method 500 for coverage hole recovery, in accordance with various aspects of the present disclosure. The processor-implemented method 500 may be performed by one or more processors such as a central processing unit (CPU), a graphics processing unit (GPU), and/or other processing unit (e.g., a digital signal processor (DSP), neural processing unit (NPU)), for example.

As shown in FIG. 5, in some aspects, the processor-implemented method 500 may include evaluating preferred radio access technology (RAT) coverage criteria (block 502). For example, the evaluating of the preferred RAT coverage criteria may be in accordance with configured cellular network parameters, signal strength, UE mobility information, vehicle mobility information, and vehicle location information.

In some aspects, the processor-implemented method 500 may include identifying a vehicle mobility state associated with vehicle specific information (block 504). For example, the UE may detect an environment of the UE, in accordance with the vehicle specific information, in response to UE being located within the coverage hole. The environment may be a garage, a tunnel, or a location where the UE is out-of-service for more than a predetermined period of time. In some aspects, the vehicle specific information comprises a vehicle ignition status, a vehicle gear mode, a no passenger detection signal, vehicle inertial measurement unit (IMU) data, and/or position location information.

In some aspects, the processor-implemented method 500 may include calculating a time to trigger a preferred RAT coverage recovery associated with the vehicle mobility state and the preferred RAT coverage criteria (block 506). For example, the time to trigger may be a current zone time to trigger and a future zones time to trigger.

In some aspects, the processor-implemented method 500 may include performing a first mode frequency scan in accordance with the time to trigger the preferred RAT coverage recovery, prior to the vehicular UE departing an area comprising a coverage hole (block 506). For example, the UE may perform the first mode frequency scan in response to a relaxed trigger condition. The relaxed trigger condition may be satisfied when a remaining time until triggering for a current zone is below a time threshold

### EXAMPLE ASPECTS

Aspect 1: A method of wireless communication at a vehicular user equipment (UE), comprising: evaluating preferred radio access technology (RAT) coverage criteria; identifying a vehicle mobility state associated with vehicle specific information; calculating a time to trigger a preferred RAT coverage recovery associated with the vehicle mobility state and the preferred RAT coverage criteria; and performing a first mode frequency scan in accordance with the time to trigger the preferred RAT coverage recovery, prior to the vehicular UE departing an area comprising a coverage hole.

Aspect 2: The method of Aspect 1, wherein the time to trigger comprises a current zone time to trigger and a future zones time to trigger.

Aspect 3: The method of Aspect 1 or 2, wherein performing the first mode frequency scan in accordance with the time to trigger the preferred RAT coverage recovery occurs in response to a relaxed trigger condition, the relaxed trigger condition being satisfied when a remaining time until triggering for a current zone is below a time threshold.

Aspect 4: The method of any of the preceding Aspects, further comprising adaptively changing the time threshold in accordance with a predicted coverage strength for a preferred RAT.

Aspect 5: The method of any of the preceding Aspects, further comprising evaluating the preferred RAT coverage criteria in accordance with configured cellular network parameters, signal strength, UE mobility information, vehicle mobility information, and vehicle location information.

Aspect 6: The method of any of the preceding Aspects, wherein the cellular network parameters comprise at least one of a cell global identifier (GCI), a physical cell identifier (PCI), an absolute radio frequency channel number (ARFCN), a RAT type, a bandwidth, or radio resource control (RRC) reconfiguration information configured by a network.

Aspect 7: The method of any of the preceding Aspects, further comprising detecting an environment of the UE, in accordance with the vehicle specific information, in response to UE being located within the coverage hole.

Aspect 8: The method of any of the preceding Aspects, wherein the area has a level of preferred RAT coverage below a signal threshold.

Aspect 9: The method of any of the preceding Aspects, wherein the vehicle specific information comprises a vehicle ignition status, a vehicle gear mode, a no passenger detection signal, vehicle inertial measurement unit (IMU) data, and/or position location information.

Aspect 10: An apparatus for wireless communication at a vehicular user equipment (UE), comprising: at least one memory; and at least one processor coupled to the at least one memory, the at least one processor configured: to evaluate preferred radio access technology (RAT) coverage criteria; to identify a vehicle mobility state associated with vehicle specific information; to calculate a time to trigger a preferred RAT coverage recovery associated with the vehicle mobility state and the preferred RAT coverage criteria; and to perform a first mode frequency scan in accordance with the time to trigger the preferred RAT coverage recovery, prior to the vehicular UE departing an area comprising a coverage hole.

Aspect 11: The apparatus of Aspect 10, wherein the time to trigger comprises a current zone time to trigger and a future zones time to trigger.

Aspect 12: The apparatus of Aspect 10 or 11, in which the at least one processor is further configured to perform the first mode frequency scan in accordance with the time to trigger the preferred RAT coverage recovery in response to a relaxed trigger condition, the relaxed trigger condition being satisfied when a remaining time until triggering for a current zone is below a time threshold.

Aspect 13: The apparatus of any of the Aspects 10-12, in which the at least one processor is further configured to adaptively change the time threshold in accordance with a predicted coverage strength for a preferred RAT.

Aspect 14: The apparatus of any of the Aspects 10-13, in which the at least one processor is further configured to evaluate the preferred RAT coverage criteria in accordance with configured cellular network parameters, signal strength, UE mobility information, vehicle mobility information, and vehicle location information.

Aspect 15: The apparatus of any of the Aspects 10-14, wherein the cellular network parameters comprise at least one of a cell global identifier (GCI), a physical cell identifier (PCI), an absolute radio frequency channel number (ARFCN), a RAT type, a bandwidth, or radio resource control (RRC) reconfiguration information configured by a network.

Aspect 16: The apparatus of any of the Aspects 10-15, in which the at least one processor is further configured to detect an environment of the UE, in accordance with the vehicle specific information, in response to UE being located within the coverage hole.

Aspect 17: The apparatus of any of the Aspects 10-16, wherein the environment comprises a garage, a tunnel, or a location where the UE is out-of-service for more than a predetermined period of time.

Aspect 18: The apparatus of any of the Aspects 10-17, wherein the vehicle specific information comprises a vehicle ignition status, a vehicle gear mode, a no passenger detection signal, vehicle inertial measurement unit (IMU) data, and/or position location information.

Aspect 19: A non-transitory computer-readable medium having program code recorded thereon, the program code executed by a processor and comprising: program code to evaluate preferred radio access technology (RAT) coverage criteria; program code to identify a vehicle mobility state associated with vehicle specific information; program code to calculate a time to trigger a preferred RAT coverage recovery associated with the vehicle mobility state and the preferred RAT coverage criteria; and program code to perform a first mode frequency scan in accordance with the time to trigger the preferred RAT coverage recovery, prior to the vehicular UE departing an area comprising a coverage hole.

Aspect 20: The non-transitory computer-readable medium of Aspect 19, wherein the time to trigger comprises a current zone time to trigger and a future zones time to trigger.

It should be noted that the methods described describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described are applicable beyond LTE, LTE-A, LTE-A Pro, or NR networks. For example, the described techniques may be applicable to various other wireless communications systems such as ultra mobile broadband (UMB), Institute of Electrical and Electronics Engineers (IEEE) 802.11 (WI-FI), IEEE 802.16 (WiMAX), IEEE 802.20, Flash-OFDM, as well as other systems and radio technologies not explicitly mentioned.

Information and signals described may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure may be implemented or performed using a general-purpose processor, a DSP, an ASIC, a CPU, an FPGA or other programmable logic device, discrete gate or transistor logic, discrete hardware components, or any combination thereof designed to perform the functions described. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described as being capable of being performed by a processor may be performed by multiple processors that, individually or collectively, are capable of performing the described functions or operations.

The functions described may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described as being capable of being performed by a memory may be performed by multiple memories that, individually or collectively, are capable of performing the described functions or operations.

As used, including in the claims, “or” as used in a list of items (e.g., a list of items prefaced by a phrase such as “at least one of” or “one or more of”) indicates an inclusive list such that, for example, a list of at least one of A, B, or C means A or B or Cor AB or AC or BC or ABC (e.g., A and B and C). Also, as used, the phrase “based on” shall not be construed as a reference to a closed set of conditions. For example, an example step that is described as “based on condition A” may be based on both a condition A and a condition B without departing from the scope of the present disclosure. In other words, as used, the phrase “based on” shall be construed in the same manner as the phrase “based at least in part on.”

As used, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth, in connection with the appended drawings, describes example configurations and does not represent all the examples that may be implemented or that are within the scope of the claims. The term “example” used means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description is provided to enable a person having ordinary skill in the art to make or use the disclosure. Various modifications to the disclosure will be apparent to a person having ordinary skill in the art, and the generic principles defined may be applied to other variations without departing from the scope of the disclosure. Thus, the disclosure is not limited to the examples and designs described but is to be accorded the broadest scope consistent with the principles and novel features disclosed.

1. A method of wireless communication at a vehicular user equipment (UE), comprising:
evaluating preferred radio access technology (RAT) coverage criteria;
identifying a vehicle mobility state associated with vehicle specific information;
calculating a time to trigger a preferred RAT coverage recovery associated with the vehicle mobility state and the preferred RAT coverage criteria; and
performing a first mode frequency scan in accordance with the time to trigger the preferred RAT coverage recovery, prior to the vehicular UE departing an area comprising a coverage hole.

2. The method of claim 1, wherein the time to trigger comprises a current zone time to trigger and a future zones time to trigger.

3. The method of claim 1, wherein performing the first mode frequency scan in accordance with the time to trigger the preferred RAT coverage recovery occurs in response to a relaxed trigger condition, the relaxed trigger condition being satisfied when a remaining time until triggering for a current zone is below a time threshold.

4. The method of claim 3, further comprising adaptively changing the time threshold in accordance with a predicted coverage strength for a preferred RAT.

5. The method of claim 1, further comprising evaluating the preferred RAT coverage criteria in accordance with configured cellular network parameters, signal strength, UE mobility information, vehicle mobility information, and vehicle location information.

6. The method of claim 5, wherein the cellular network parameters comprise at least one of a cell global identifier (GCI), a physical cell identifier (PCI), an absolute radio frequency channel number (ARFCN), a RAT type, a bandwidth, or radio resource control (RRC) reconfiguration information configured by a network.

7. The method of claim 1, further comprising detecting an environment of the UE, in accordance with the vehicle specific information, in response to UE being located within the coverage hole.

8. The method of claim 1, wherein the area has a level of preferred RAT coverage below a signal threshold.

9. The method of claim 1, wherein the vehicle specific information comprises a vehicle ignition status, a vehicle gear mode, a no passenger detection signal, vehicle inertial measurement unit (IMU) data, and/or position location information.

10. An apparatus for wireless communication at a vehicular user equipment (UE), comprising:
at least one processor coupled to at least one memory, the at least one processor configured to:
evaluate preferred radio access technology (RAT) coverage criteria;
identify a vehicle mobility state associated with vehicle specific information;
calculate a time to trigger a preferred RAT coverage recovery associated with the vehicle mobility state and the preferred RAT coverage criteria; and
perform a first mode frequency scan in accordance with the time to trigger the preferred RAT coverage recovery, prior to the vehicular UE departing an area comprising a coverage hole.

11. The apparatus of claim 10, wherein the time to trigger comprises a current zone time to trigger and a future zones time to trigger.

12. The apparatus of claim 10, wherein the at least one processor is further configured to perform the first mode frequency scan in accordance with the time to trigger the preferred RAT coverage recovery in response to a relaxed trigger condition, the relaxed trigger condition being satisfied when a remaining time until triggering for a current zone is below a time threshold.

13. The apparatus of claim 12, wherein the at least one processor is further configured to adaptively change the time threshold in accordance with a predicted coverage strength for a preferred RAT.

14. The apparatus of claim 10, wherein the at least one processor is further configured to evaluate the preferred RAT coverage criteria in accordance with configured cellular network parameters, signal strength, UE mobility information, vehicle mobility information, and vehicle location information.

15. The apparatus of claim 14, wherein the cellular network parameters comprise at least one of a cell global identifier (GCI), a physical cell identifier (PCI), an absolute radio frequency channel number (ARFCN), a RAT type, a bandwidth, or radio resource control (RRC) reconfiguration information configured by a network.

16. The apparatus of claim 10, wherein the at least one processor is further configured to detect an environment of the UE, in accordance with the vehicle specific information, in response to UE being located within the coverage hole.

17. The apparatus of claim 16, wherein the environment comprises a garage, a tunnel, or a location where the UE is out-of-service for more than a predetermined period of time.

18. The apparatus of claim 10, wherein the vehicle specific information comprises a vehicle ignition status, a vehicle gear mode, a no passenger detection signal, vehicle inertial measurement unit (IMU) data, and/or position location information.

19. A non-transitory computer-readable medium having program code recorded thereon, the program code executed by a processor and comprising:
program code to evaluate preferred radio access technology (RAT) coverage criteria;
program code to identify a vehicle mobility state associated with vehicle specific information;
program code to calculate a time to trigger a preferred RAT coverage recovery associated with the vehicle mobility state and the preferred RAT coverage criteria; and
program code to perform a first mode frequency scan in accordance with the time to trigger the preferred RAT coverage recovery, prior to the vehicular UE departing an area having a level of preferred RAT coverage below a signal threshold, the area comprising a coverage hole.

20. The non-transitory computer-readable medium of claim 19, wherein the time to trigger comprises a current zone time to trigger and a future zones time to trigger.
